(19) United States
(12) Patent Application Publication
(10) Pub. No.: US 2004/0046530 A1
(43) Pub. Date: Mar. 11, 2004

(54) Power plant and a method for operation thereof

(76) Inventor: Peter Hessling, Vallentuna (SE)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/275,294

(22) PCT Filed: May 3, 2001
(86) PCT No.: PCT/SE01/00948

(30) Foreign Application Priority Data
May 3, 2000 (SE) 0001611-3

(51) Int. Cl. H02H 7/06; H02P 9/00; H02P 11/00

(52) U.S. Cl. 322/29

(57) ABSTRACT

A power plant comprises at least one turbine (5) driven by a variable medium flow and an electric generator (4) driven by the turbine and the induced voltage of which being an unambiguous function of the number of revolutions of the turbine. The plant has also first members (12) for detecting the electric power generated by the generator, second members (11) for detecting the voltage on the output of the generator, means (10) adapted to compare the values detected for said power and voltage with an ideal relation predetermined for the generator between these two quantities and an arrangement (10) adapted to regulate the induced voltage of the generator and thereby the number of revolutions of the turbine so that said ideal relation between power and voltage is obtained.

### FIELD OF THE INVENTION AND PRIOR ART

The present invention relates to a power plant comprising at least one turbine driven by a variable medium flow and an electric generator driven by the turbine and the induced voltage of which is an unambiguous function of the number of revolutions of the turbine, and a method for operation of such a plant.

The invention is not restricted to any particular ranges with respect to power or voltage levels.

Said medium flow could in principle be any, but since this flow may inevitably vary for a medium flow in the form of an air flow in connection with wind power stations, the particular case of a wind power plant will hereinafter be described for illuminating but accordingly not in any way limiting the invention.

The electric generator could also be of synchronous as well as asynchronous type, but the case of a synchronous generator will hereinafter primarily be described without any intention to restrict the invention.

It is further pointed out that the power plant may of course include a high number of power stations or plants with an electric generator driven by a turbine.

The magnitude of the power delivered by a wind power generator depends upon the wind velocity and the frequency of the alternating voltage delivered by the generator, i.e. in the practice the number of revolutions of the rotor of the generator. Thus, for a given wind velocity there is a maximum for the electric power that may be delivered by the wind power generator for a given number of revolutions of the generator. This number of revolutions increases with the wind velocity. More exactly, the following relations are valid:

P˜Cₚ·v³ (1)

in which P is the mechanical power introduced through the turbine and v is the wind velocity. This connection is valid for wind velocities v≦vₙ, in which vₙ is a nominal wind velocity, which is often about 12 m/sec. Cₚ depends upon λ,

$$λ = \frac{ R ω}{v} \qquad ( 2 )$$

in which R is the radius defined by the turbine blades of the turbine and ω is the angular velocity of the turbine and is accordingly proportional to the number of revolutions n of the generator. How Cₚ is varied with λ is determined by the design of the turbine blades and the turbine construction, and Cₚ may for example vary with λ in the way shown in FIG. 1. This means that for a given λ=λ₀ Cₚ will be a maximum, which means that a maximum power may be generated. This means in its turn that if the wind velocity is changed by a certain factor the number of revolutions of the generator should be changed by the same factor, so that λ is kept constant on the value for which Cₚ is a maximum.

Thus, it is as such no problem to calculate the number of revolutions of the turbine and thereby of the generator desired for a given wind velocity for generating a maximum power, but the problem is to find an advantageous way to carry out a regulation of the number of revolutions of the generator so that the generator operates in an optimum way and delivers the highest possible power at fluctuating wind velocities. It has until now often been tried to solve the problem by arranging members detecting the wind velocity at the turbine, and a calculation of the optimum number of revolutions of the generator is then carried out depending thereupon. The generator may then in different ways be forced to assume the optimum number of revolutions calculated. Such a wind measurement for obtaining an optimum power is not as precise as desired and seems to be unnecessarily complicated. This is particularly the case for plants having a high number of wind power stations interconnected.

By U.S. Pat. No. 5,798,631 a wind power plant is known, which has an arrangement adapted to regulate a converter by utilizing the principle of adaptive maximum power point tracking (MPPT=maximum power point). However, this type of control is often not quick enough and has no chance of reacting when quick changes take place, such as when suddenly wind shadow occurs.

### SUMMARY OF THE INVENTION

The object of the present invention is to provide a power plant and a method for operation thereof of the type defined in the introduction, which solves the problems discussed above.

This object is according to the invention obtained by providing such a power plant, which further comprises first members for detecting the electric power generated by the generator, second members for detecting the voltage on the output of the generator, means adapted to compare the values detected for said power and said voltage with an ideal relation between these two quantities predetermined for the generator and an arrangement adapted to regulate the induced voltage of the generator and thereby the number of revolutions of the turbine so that said ideal relation between power and voltage is obtained, and a method according to the independent appended method claim.

Thus, the invention is based on the understanding that it may be utilized that the induced voltage of the electric generator is an unambiguous function of the number of revolutions of the turbine and this and thereby the counteracting moment for the turbine and the number of revolutions of the latter may be regulated on the basis of values of the voltage out from the generator and the power out from the same measured, which follow a predetermined ideal relation of maximum power at a given medium flow, in the wind power case at a given wind velocity. This relation is determined by the construction of the power plant and may be calculated in advance and be stored in a memory for said comparison. The relation between the voltage U out from the generator and the maximum deliverable power P out from the generator for a given synchronous generator is illustrated in the appended FIG. 4. Furthermore, it is shown in the appended FIG. 3 how the generator may be simplified by a source 1 for induced voltage E and an inner impedance Z(2), in which the voltage U out from the generator, the induced voltage E and the voltage across the inner impedance Z (IZ, in which I is the current through the impedance) satisfy the pointer diagram to the right in FIG. 3. It is also illustrated in FIG. 2 how the induced voltage E is related to the number of revolutions n of the generator, in which the linear relation a shows the case of a synchronous generator having permanent magnets., while it is shown through two other curves b, c that the induced voltage E could be another function of the number of revolutions, which could be valid in the case of an asynchronous generator or a synchronous generator having a particularly selected control of the field winding, so that E is a non-linear function of the number of revolutions. This illustrates how the number of revolutions of the generator may be modified by modifying the induced voltage. Thus, this is according to the invention made by putting the input mechanical power P˜Cₚ·v³ equal to the electric power out from the generator inclusive losses, so that a relation between the voltage and the electric power for an optimum function of the generator is determined, which corresponds to a constant λ for which Cₚ is the maximum. Thus, a very accurate regulation of the number of revolutions of the generator may in this way take place according to the curve giving a maximum power only by measuring the voltage and the power out from the generator without any necessity of carrying out any direct measurement of the wind velocity, the number of revolutions or other parameters. If the comparison of the power and voltage measured corresponds to a point being spaced from the ideal relation therebetween, a regulation of the induced voltage takes place so that the number of revolutions of the generator is modified and the ideal relation between the power and the voltage is obtained. This type of regulation is also quick and manages to follow rapid changes of operation conditions, such as suddenly occurring or disappearing wind shadow in the wind power case.

It is pointed out that the voltage U and the power P do not at all have to be measured directly at the generator, but these parameters may be determined by measuring these quantities much later in the electric circuit from the generator, such as after rectifying or possibly even inversion following thereupon, and calculate back the correspondence of these values in voltage out from the generator and power delivered thereby. Actually, in most cases there is no need to carry out such calculation backwardly, but the ideal relation compared with is a relation between the voltage and the power at the places for the measuring thereof.

According to a preferred embodiment of the invention the arrangement is adapted to accomplish said regulation of the induced voltage of the generator by regulating the voltage on the output of the generator. It appears from the pointer diagram to the right in FIG. 3 that this constitutes a possible way to regulate the induced voltage E and thereby the number of revolutions n, and this may be achieved by comparatively simple means in different ways according to further preferred embodiments of the invention discussed directly hereinafter.

According to such an embodiment the output of the generator is connected to a rectifier for converting the alternating voltage generated by the generator into a direct voltage, the rectifier is through a direct voltage line connected to an inverter connected to an alternating voltage network, and said arrangement is adapted to regulate the voltage generated on the output of the generator by regulating the input voltage to the inverter by controlling current valves included therein. By making the inverter dependent upon the values measured for the power and the voltage the voltage out from the generator may be indirectly regulated by modifying the voltage into the inverter and the induced voltage E and thereby the number of revolutions n of the generator may by that be modified for obtaining the ideal relation between the number of revolutions and the medium flow, such as wind velocity. It is pointed out that the component I·Z also may be influenced by a change of the current I at such a regulation.

According to another preferred embodiment of the invention, which constitutes a modification of the previous embodiment, the control of the inverter is independent of values detected for the power and the voltage, and the arrangement is instead adapted to regulate the output voltage from the generator by modifying the level of the direct voltage between the rectifier and the inverter. This may advantageously take place by arranging a controllable DC/DC-converter between the rectifier and the inverter. It is also possible to arrange a transformer between the generator and the rectifier for modifying the level of the voltage out from the generator.

According to another preferred embodiment of the invention the arrangement comprises members adapted to modify the inner impedance of the generator for regulating the induced voltage of the generator for modifying said ideal relation and obtaining it. It is pointed out that the ideal relation between said power and voltage may through changing the impedance in this way also be modified, so that there will be another curve aimed at than before to be compared with. In some cases it may be very advantageous to influence the induced voltage and thereby the number of revolutions of the generator by modifying the inner impedance, since the flexibility of the generator and thereby of the power plant may in this way be modified. More exactly, a change of the inner impedance of the generator may result in a possibility to a more rapid adaption to the ideal relation between the medium flow and the number of revolutions, so that for example in the wind power case at a gust, which means an increased number of revolutions and a higher current resulting in a higher power and a higher counteracting moment, the impedance may be increased, so that the number of revolutions may rapidly be increased while adapting the counteracting moment or torque. Should no change of impedance take place the raising and lowering of the number of revolutions would be considerably slower, so that it will be possible through said impedance change to lie close to the curve for the ideal relation between the wind velocity and the number of revolutions a longer time before, at and after gusts. It is then particularly advantageous at a fixed output voltage from the generator depending upon that several generators are connected to a common point having a certain voltage, to be able to regulate the impedance for each individual generator, since the wind velocities may be different at the different generators. At a comparatively high value of the impedance (see pointer diagram to the right in FIG. 3) a better possibility to control the number of revolutions of each individual generator by changing the inner impedance thereof and thereby an increased flexibility of the plant is obtained, so that at varying wind conditions comparatively large changes of the number of revolutions of the different generators may be obtained and thereby the total power that may be generated by the plant may be increased.

According to a preferred embodiment of the invention said members for modifying the inner impedance of the generator comprise additional windings of the generator for feeding current therethrough for modifying the magnetic flux of the generator and thereby the impedance thereof. Another possibility to obtain a modification of the inner impedance of the generator consists in arranging shunt capacitors and/or series reactances for switching in a variable number thereof in the electric circuit of the generator.

According to another preferred embodiment of the invention said arrangement comprises a tap changer arranged in the generator and members adapted to control the tap changer for modifying the induced voltage of the generator and modifying said ideal relation between the output voltage of the generator and the electric power generated by the generator. Thus, by arranging such a tap changer and controlling it the whole relation curve between the power and the voltage may be moved so that it comes closer to the conditions prevailing and the existing operation point arrives at the ideal curve corresponding to the ideal relation between the medium flow and the number of revolutions of the generator.

It is here pointed out that the different embodiments described above may very well be combined with each other, so that for example both the output voltage of the generator and the inner impedance of the generator may be controlled. This could then sometimes take place simultaneously and it would for example be possible to only regulate the induced voltage of the generator when there are a plurality of generators in a plant by regulating the output voltage of the generator as long as the conditions are the same for the different generators and utilize the impedance regulation at different conditions for the different generators, and primarily utilize the impedance regulation at quicker changes of the conditions, such as at suddenly occurring gusts for enabling rapid changes of the number of revolutions of the generator.

According to another preferred embodiment of the invention the plant comprises a plurality of turbine-generator-units connected in parallel to a common arrangement adapted to accomplish a common regulation of the induced voltage of all said generators dependent upon a voltage detected at a common point and a detected average power from the generators in a common point for regulating said induced voltage so that an ideal relation between said average power and voltage is obtained. By regulating all the units, i.e. power stations, in this way equally depending upon the average power and voltage measured a comparatively good adaption of the number of revolutions of the generators to the medium flow prevailing and by that a high efficiency of the power plant may be obtained.

According to another preferred embodiment of the invention, which constitutes a further development of the last mentioned embodiment, the arrangement comprises also means for individually regulating the induced voltage of each individual generator depending upon the voltage on the output of the generator and the power delivered out from the generator. This individual regulation is advantageously achieved by modifying the inner impedance of the respective generator. It gets by such an individual regulation possible to obtain an adaption of the number of revolutions of each generator to the conditions prevailing at each individual generator, so that for example to different extents by gusts or at all by wind influenced wind power stations of a park of wind power stations may be controlled in an optimum way and thereby a maximum power may be generated. This embodiment of a common control combined with an individual control of the generators is advantageous, since the individual control may be switched off or disconnected, when the conditions are the same at the different generators and the losses may in such a case be kept lower than in the case of a possible embodiment where only individual control of the generators exists.

The invention also relates to preferred embodiments of the method according to the invention defined in the claims, and the function and the advantages thereof appear with no uncertainty from the discussion above of the preferred embodiments of the plant according to the invention.

### BRIEF DESCRIPTION OF THE DRAWINGS

With respect to the appended drawings, below follows a description of preferred embodiments of the invention cited as examples.

In the drawings:

FIG. 1 is a graph illustrating the dependence of Cₚ on λ for a wind power generator,

FIG. 2 is a graph schematically illustrating different possible unambiguous functions of the induced voltage of different generators versus the number of revolutions thereof,

FIG. 3 is a simplified electrical diagram of an electric generator and a pointer diagram belonging thereto,

FIG. 4 is a graph illustrating the relation between the output voltage U and delivered power P of a determined generator at an ideal relation between medium flow and rotation speed of the generator,

FIG. 5 is a schematic view of a wind power plant of the type, to which the invention may be applied,

FIG. 6 is a view being simplified with respect to FIG. 5 of a power plant according to a first preferred embodiment of the invention,

FIG. 7 is a view corresponding to FIG. 6 of a power plant according to a second preferred embodiment of the invention,

FIG. 8 is a view corresponding to FIG. 6 of a power plant according to a third preferred embodiment of the invention,

FIG. 9 is a view corresponding to FIG. 6 of a power plant according to a fourth preferred embodiment of the invention, and

FIGS. 10-12 are very schematical views of power plants having a plurality of generators with different regulation possibilities according to the invention.

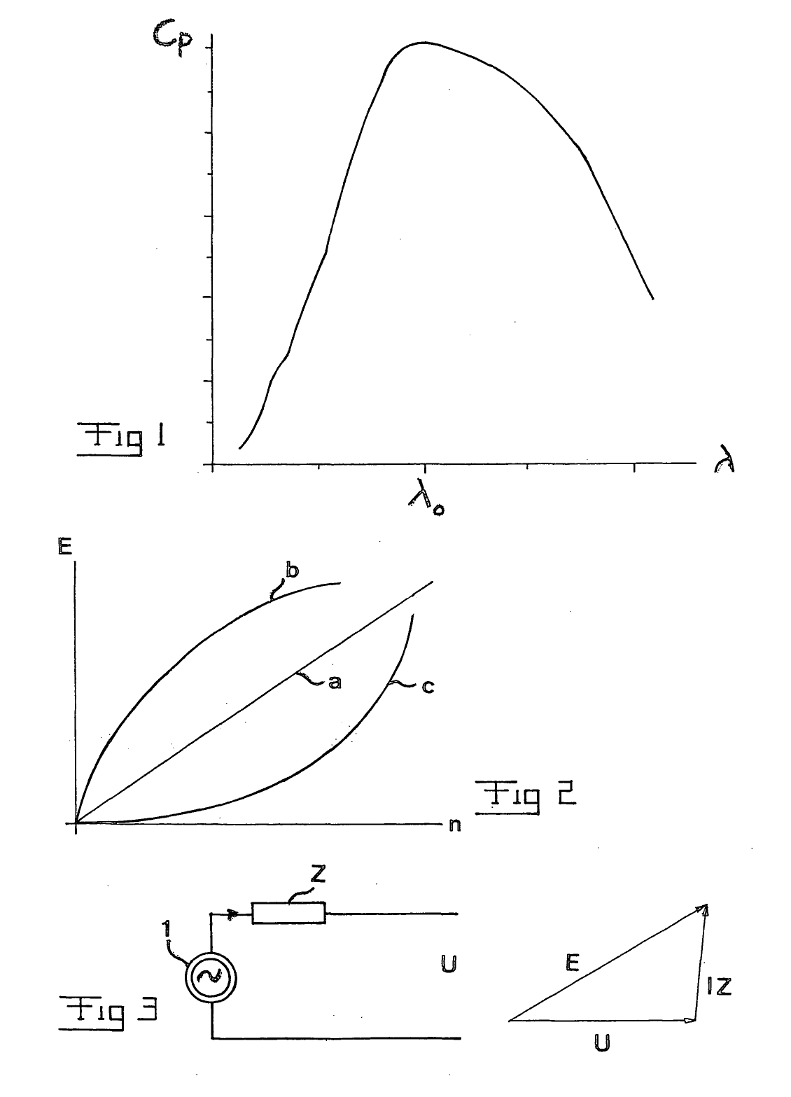

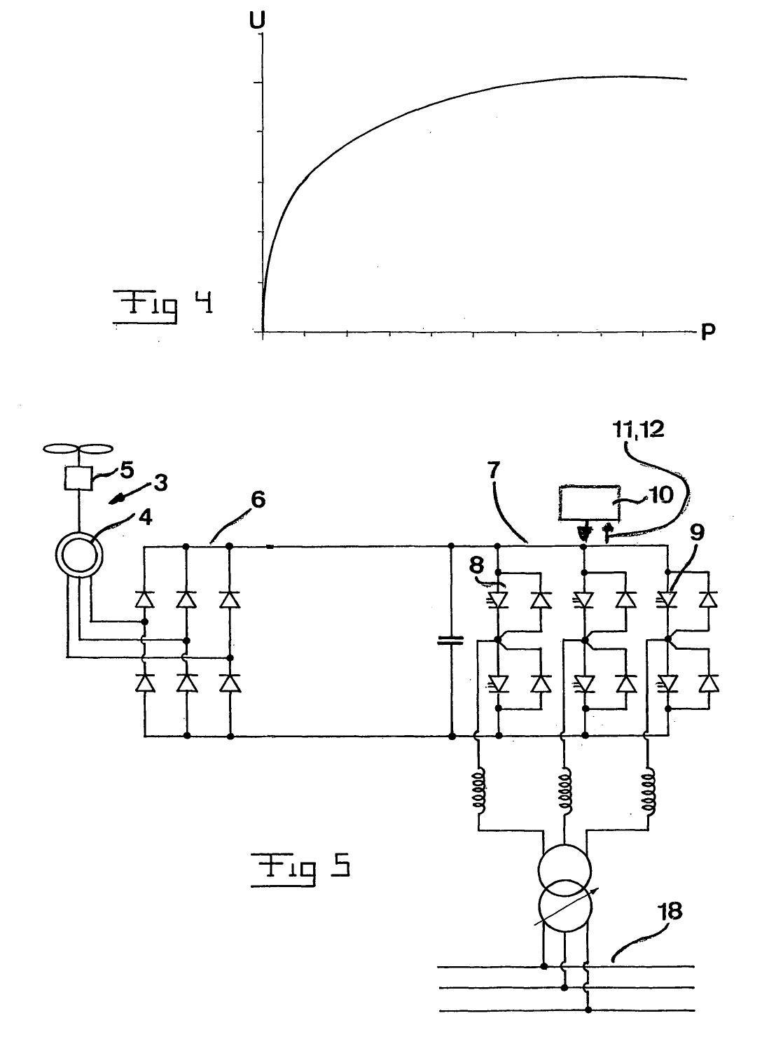

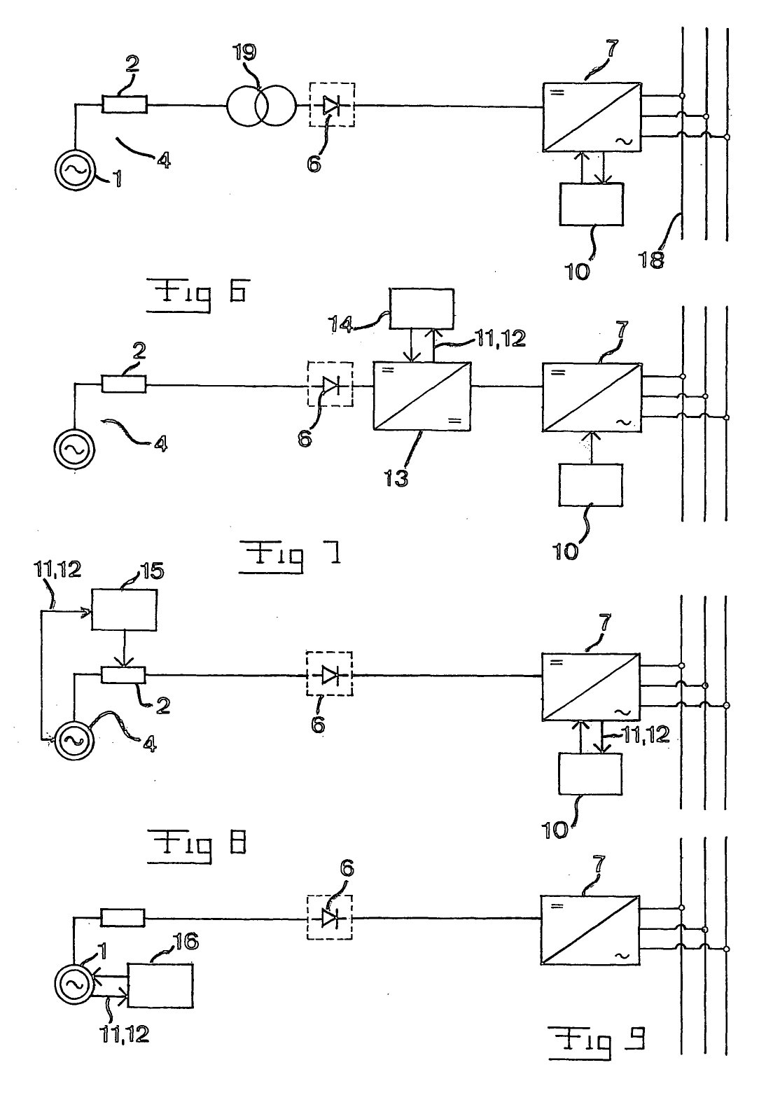

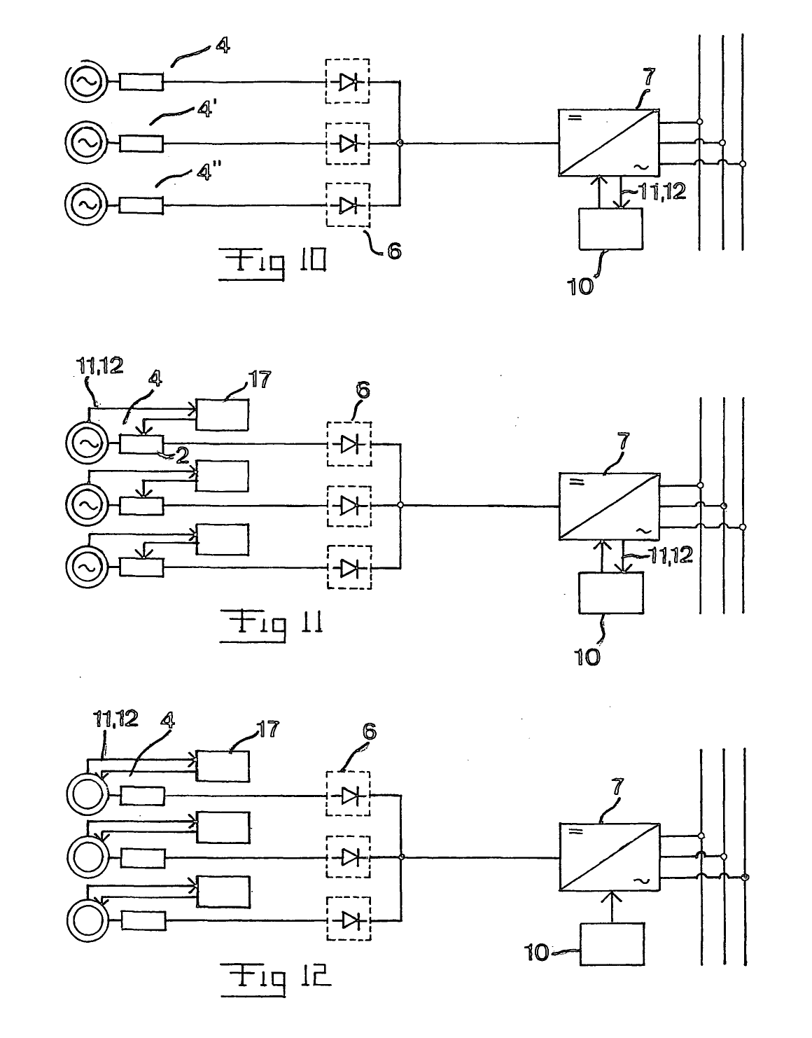

### DETAILED DESCRIPTION OF PREFERRED EMBODIMENTS OF THE INVENTION

A wind power plant according to the invention having a wind power station 3 comprising a generator 4 and a turbine 5 connected thereto and driving the generator is schematically illustrated in FIG. 5, but a number of such wind power stations would in the practice be included in the wind power plant. A so-called wind power park may then be built by a very high number of such so-called wind power stations, which may be distributed over a substantial landscape and/or water area. These may for example be placed according to a 24×6 matrix pattern with a distance of say 300 meters between each short and 500 meters between each long row.

The generator is here a synchronous generator with permanent magnets, the number of revolutions of which may not be modified in an alternating voltage network and therefore has to have a rectifier 6 connected therebetween. The rectifier 6 is a traditional diode rectifier. An electric direct voltage connection is arranged between the rectifier 6 and an inverter 7, the alternating voltage side of which is connected to a transmission or distribution network 18. The inverter 7 may be located at a comparatively large distance from the wind power station, especially when the wind power station is located at sea the inverter may be arranged on land. The inverter comprises in a conventional way current valves 8, the power semiconductor devices 9 of which, which may for example be IGBT's or GTO's, are controlled by a regulating arrangement 10.

The plant further comprises members 11 schematically indicated, by an arrow, here between the regulating arrangement and the inverter, for measuring the voltage into the inverter, from which the voltage out from the generator may be derived by suitable calculations, and members 12 indicated by the same arrow for measuring the current of the direct voltage connection, which enables establishing of a measure of the power reaching the inverter and thereby indirectly the power out from the generator 4. Accordingly, the measuring of the quantities current and voltage preferably takes place for the signals of input and/or output.

A wind power plant according to the invention of the type shown in FIG. 5 is schematically illustrated in FIG. 6, and the members 11 and 12 are in this embodiment adapted to send the detecting signals thereof to the regulating arrangement 10, which is adapted to make its regulation dependent upon these signals. More exactly, the regulating arrangement 10 here senses the ideal relation illustrated in FIG. 4 between the voltage out from the generator and the power delivered thereby and is adapted to make a comparison of the values measured of these values for adapting the control of the current valves of the inverter 7 thereto, so that the input voltage to the inverter will be influenced and thereby also the output voltage U from the generator (see FIG. 3) and thereby the induced voltage of the generator may be regulated and therethrough the number of revolutions thereof. In this and the following Figures the rectifier is symbolized by the symbol for a diode.

FIG. 7 illustrates schematically a plant being slightly modified with respect to the one according to FIG. 6, by the fact that here a DC/DC-converter 13 with an adjustable conversion ratio is arranged in the direct voltage connection between the rectifier 6 and the inverter 7. The detecting signals from the members 11 and 12 are here sent to an arrangement 14 for regulating the voltage transformation obtained by the converter 13 so as to in this way control the input voltage to the DC/DC-converter 13 and thereby indirectly the output voltage U of the generator. The arrangement 10 for regulating the inverter 7 is fixed to control this in a predetermined way being constant over time.

Another possible embodiment of the invention is shown in FIG. 8, and in this embodiment the signals from the members 11 and 12 are sent to an arrangement 15 for regulating the inner impedance 2 of the generator. This embodiment is preferably combined with any of the embodiments according to FIG. 6 or 7, so that there is a particular regulating arrangement for also controlling the voltage out from the generator, and it is then possible that the arrangement last mentioned needs knowledge about the changes made in the system, i.e. here changes of the inner impedance of the generator, since this means that the relation according to FIG. 4 is changed and a new curve may possibly need to be chosen. The regulation of the impedance 2 may as already described take place in different ways, such as through feeding current through additional windings of the generator for modifying the magnetic flux of the generator, switching in and switching out shunt capacitors and/or series reactances in the electric circuit of the generator.

A further embodiment of the invention is illustrated in FIG. 9, in which the members 11 and 12 send their signals to an arrangement 16 in the form of a tap changer of the generator for modifying the induced voltage E of the generator by controlling the tap changer.

It is schematically illustrated in FIG. 10 how a plurality of generators 4, 4′, 4″ are connected to a common inverter 7 through rectifiers. The voltage U and the current I are here measured and thereby indirectly the power, the total power P from the generators and thereby also the average power thereof and the arrangement 10 for controlling the inverter controls this depending upon these values for adjusting a common output voltage to the different generators for obtaining a maximum power at a given wind velocity.

It is illustrated in FIG. 11 how the embodiment according to FIG. 10 may be combined with arrangements 17 for individually controlling the induced voltage of each individual generator depending upon the power and voltage delivered out from the generator in question. This individual regulation may advantageously be constituted by a regulation of the inner impedance of the generator, while the common regulation takes place by a direct influence upon the output voltage from the generators through a regulation of the control of the inverter by the arrangement 10. It is advantageous to switch off the individual regulations should substantially the same conditions prevail at the different generators, and consequently the losses may be kept down.

Finally, a plant according to an embodiment differing from the one according to FIG. 11 by the fact that here the common regulation is removed and that the impedance control has been exchanged by a tap changer control, since the regulation range otherwise will be too narrow without group control, is shown in FIG. 12. This embodiment could be advantageous in applications where the different generators very often operate under various conditions, so that an individual regulation may then result in a considerably higher efficiency of the plant.

The invention is of course not in any way restricted to the preferred embodiments described above, but many possibilities to modifications thereof will be apparent to a person skilled in the art without departing from the basic idea of the invention as defined in the claims.

The generator could for example be an asynchronous generator and in such a case the rectifier and the inverter could possibly be omitted.

As already stated above measurements of values for determining the voltage and the power out from the respective generator may take place at several different locations, very well at a distance of several tens of kilometers from the generator should then the influence of the impedance of the intermediate line be considered.

The voltage out from the generator is typically considerably higher than 1 kV, advantageously above 10 kV, but other levels are also conceivable.

It is pointed out that “detecting power” as mentioned in the claims also comprises indirect detection. Current and voltage may for example be measured and thereby a size of the power be obtained.

1. A power plant comprising at least one turbine (5) driven by a variable medium flow and an electric generator (4) driven by the turbine and the induced voltage of which is an unambiguous function of the number of revolutions of the turbine, characterized in that the plant further comprises first members (12) for detecting the electric power generated by the generator, second members (11) for detecting the voltage on the output of the generator, means (10, 14-17) adapted to compare the values detected for said power and said voltage with an ideal relation between these two quantities predetermined for the generator and equal to a maximum of said power at a given medium flow and an arrangement (10, 14-17) adapted to regulate the induced voltage of the generator and thereby the number of revolutions of the turbine so that said ideal relation between power and voltage is obtained.

2. A plant according to claim 1, characterized in that the turbine (5) and the generator (4) are parts of a wind power station (3), so that said given medium flow is a given wind velocity.

3. A plant according to claim 1 or 2, characterized in that the arrangement (10, 14) is adapted to accomplish said regulation of the induced voltage of the generator by regulating the voltage on the output of the generator (4).

4. A plant according to claim 3, characterized in that the output of the generator is connected to a rectifier (6) for converting the alternating voltage generated by the generator into a direct voltage, that the rectifier is through a direct voltage line connected to an inverter (7) connected to an alternating voltage network (18), and that said arrangement (10) is adapted to regulate the voltage generated on the output of the generator by regulating the input voltage to the inverter by controlling current valves included therein.

5. A plant according to claim 3, characterized in that the output of the generator is connected to a rectifier (6) for converting the alternating voltage generated by the generator into a direct voltage, that the rectifier is through a direct voltage line connected to an inverter (7) connected to an alternating voltage network (18), and that said arrangement (10, 14) is adapted to accomplish a control of the current valves of the inverter being constant over time and regulate the output voltage from the generator by modifying the level of the direct voltage between the rectifier and the inverter.

6. A plant according to claim 4 or 5, characterized in that the arrangement comprises a DC/DC-converter (13) arranged between the rectifier (6) and the inverter (7) and controllable for modifying the level of the direct voltage.

7. A plant according to any of claims 4-6, characterized in that the arrangement comprises a transformer (19) arranged between the generator (4) and the rectifier (6) for modifying the level of the voltage on the output of the generator.

8. A plant according to any of the preceding claims, characterized in that the arrangement comprises members (15, 17) adapted to modify the inner impedance (2) of the generator (4) for regulating the induced voltage of the generator for modifying said ideal relation and obtaining it.

9. A plant according to claim 8, characterized in that said members (15, 17) for modifying the inner impedance of the generator comprises additional windings of the generator (4) for feeding current therethrough for modifying the magnetic flux of the generator and thereby the impedance thereof.

10. A plant according to claim 8 or 9, characterized in that said members (15, 17) for regulating the inner impedance of the generator comprise shunt capacitors and members for switching in a variable number thereof in the electric circuit of the generator (4) for varying the inner impedance of the generator.

11. A plant according to any of claims 8-10, characterized in that said members (15, 17) for regulating the inner impedance of the generator (4) comprise series reactances and members for switching in a variable number thereof in the electric circuit of the generator for varying the inner impedance of the generator.

12. A plant according to any of the preceding claims, characterized in that said arrangement comprises at tap changer (16) arranged in the generator (4) and members adapted to control the tap changer for modifying the induced voltage of the generator and modifying said ideal relation between the output voltage of the generator and the electric power generated by the generator.

13. A plant according to any of the preceding claims, characterized in that said arrangement comprises series reactances and/or shunt capacitances arranged in an alternating voltage line connected to the generator and which may be switched in at a variable number into this line.

14. A plant according to any of the preceding claims, characterized in that the generator (4) is a synchronous generator.

15. A plant according to claim 14, characterized in that the generator is a synchronous generator (4) having a rotor with permanent magnets.

16. A plant according to any of the preceding claims, characterized in that it comprises a plurality of turbine-generator-units connected in parallel to a common arrangement (10) adapted to accomplish a common regulation of the induced voltage of all said generators (4, 4′, 4″) dependent upon a voltage detected at a common point and a detected average power from the generators in a common point for regulating said induced voltage so that an ideal relation between said average power and voltage is obtained.

17. A plant according to claim 16, characterized in that the arrangement also comprises means (17) for individually regulating the induced voltage of each individual generator (4, 4′, 4″) dependent upon the voltage on the output of the generator and the power delivered from the generator.

18. A plant according to any of claims 1-15, characterized in that it comprises a plurality of turbine-generator-units connected in parallel to a common voltage, and that said arrangement comprises means (17) for individually regulating the induced voltage of each generator depending upon the output voltage and power detected at each generator.

19. A method for operation of a power plant for generating electric power through at least one electric generator (4) driven by a turbine (5) driven by a variable medium flow, the induced voltage of the generator being an unambiguous function of the number of revolutions of the turbine, characterized in that the electric power (P) generated by the generator and the voltage (U) on the output of the generator are detected, that the values detected for said power and voltage are compared with an ideal relation between these two quantities predetermined for the generator and equal to a maximum of said power at a given medium flow, and that the induced voltage (E) of the generator and thereby the number of revolutions of the turbine are regulated on basis of the result of this comparison so that said ideal relation between the power and the voltage is obtained.

20. A method according to claim 19, characterized in that the operation relates to a wind power plant with said turbine (5) and generator (4) being parts of a wind power station (3), so that said given medium flow is a given wind velocity.

21. A method according to claim 19 or 20, characterized in that the induced voltage of the generator is regulated by regulating the voltage on the output of the generator.

22. A method according to claim 21, characterized in that the plant has the output of the generator connected to a rectifier (6) for converting the alternating voltage generated by the generator (4) into direct voltage and the rectifier is through a direct voltage line connected to an inverter (7) connected to an alternating voltage network (18), and that the voltage generated on the output of the generator is regulated by regulating the input voltage to the inverter by controlling current valves included therein.

23. A method according to claim 21, characterized in that the plant has the output of the generator connected to a rectifier (6) for converting the alternating voltage generated by the generator (4) into direct voltage and the rectifier is through a direct voltage line connected to an inverter (7) connected to an alternating voltage network (18), and that the current valves of the inverter are controlled in a way being constant over time and the output voltage of the generator is regulated by modifying the level of the direct voltage between the rectifier and the inverter.

24. A method according to claim 22 or 23, characterized in that a DC/DC-converter (13) arranged between the rectifier (6) and the inverter (7) is controlled for modifying the level of the direct voltage.

25. A method according to any of claims 22-24, characterized in that the level of the voltage out from the generator is modified by a transformer (19) arranged between the generator (4) and the rectifier (6).

26. A method according to any of claims 19-25, characterized in that the inner impedance (2) of the generator is modified for regulating the induced voltage of the generator for modifying said ideal relation and obtaining it.

27. A method according to claim 26, characterized in that the inner impedance of the generator is modified by feeding current through additional windings of the generator for modifying the magnetic flux of the generator and thereby the impedance thereof.

28. A method according to claim 26 or 27, characterized in that a variable number of shunt capacitors are switched in in the electric circuit of the generator for varying the inner impedance of the generator.

29. A method according to any of claims 26-28, characterized in that a variable number of series reactances are switched in in the electric circuit of the generator for varying the inner impedance of the generator.

30. A method according to any of claims 21-29, characterized in that a tap changer of the generator is controlled for modifying the induced voltage of the generator and modifying said ideal relation between the output voltage of the generator and the electric power generated by the generator.

31. A method according to any of claims 21-30, characterized in that for a plurality of turbine-generator-units connected in parallel to a common point the voltage at a common point is detected and the average power delivered from the generators (4, 4′, 4″) in a common point is detected, and that the induced voltage of all said generators are regulated in common dependent upon the detected values of the voltage and the average power, so that an ideal relation between said average power and the voltage is obtained.

32. A method according to claim 31, characterized in that the induced voltage of each individual generator (4, 4′, 4″) is also regulated depending upon the voltage on the output of the generator and the power delivered out from the generator.

33. A method according to claim 32, characterized in that at substantially the same voltage on the outputs of the different generators (4, 4′, 4″) and substantially the same delivered power out from the different generator the individual regulation of the induced voltage is switched off and only the common regulation is carried out.

34. A method according to any of claims 21-31, characterized in that at a plurality of turbine-generator-units connected in parallel to a common voltage the voltage and the power out from each individual generator are detected and the induced voltage of each generator is regulated individually.
